(19) United States
(12) Patent Application Publication
(10) Pub. No.: US 2004/0051321 A1
(43) Pub. Date: Mar. 18, 2004

(54) Shock-absorbing bumper device

(76) Inventors: Isao Hanai, Aichi (JP); Mikio Hanai, Aichi (JP); Makoto Hanai, Aichi (JP)

Correspondence Address: Jeffrey D. Washville, LORUSSO LOUD & KELLY LLP, 440 Commercial Street, Boston, MA, 02109, US

(21) Appl. No.: 10/664,266

(22) Filed: Sep. 17, 2003

(30) Foreign Application Priority Data
Sep. 17, 2002 (JP) 2002-269498
Jul. 25, 2003 (JP) 2003-201671

(51) Int. Cl. B60R 19/26

(52) U.S. Cl. 293/132

(57) ABSTRACT

A unique shock-absorbing bumper device for use in absorbing collision energy in all bumper assembly systems, and more specifically automobiles. A simple efficient structure is designed for ease of installation and removal after impact, and to provide high performance in absorbing colliding energy, which prevents a driver and passengers from severe injury caused by a car colliding with an object. This system may be used in car doors for absorbing side impacts.

### CROSS REFERENCE TO RELATED APPLICATIONS

This application claims benefit to Japanese patent application No. 2002-269498 filed Sep. 17, 2002, now abandoned and Japanese patent application no. 2003-201671 filed Jul. 25, 2003, the contents of which are incorporated in their entirety.

### BACKGROUND OF THE INVENTION

An ordinary bumper, which is commonly employed at both the front and rear end of a vehicle or in areas prone to impact by objects such as vehicles or other heavy or fast moving objects where the aim is to lower shock (impact) to one or both of the objects that collide. Most bumpers are utilized in automobiles to protect the car driver or its passenger at a time of car impact into an object that may cause harm due to its speed or weight.

There are several other conventional shock-absorbing bodies; some utilize a spring device between car frame and bumper, others employ gum or blister plastic resin as a compound of the bumper itself to increase elasticity.

Another common method employs a front-end pressure absorbing gum containing a front-end pressure absorbing space; an outside space of pressure absorbing gum on a rear-end board coated by vibration (pressure) absorbing gum; and a vibration absorbing board space together with a front-end board that is also coated by a vibration (pressure) absorbing gum. See Patent Document 110-129372 (1, Diagram 1-3)

The ordinary method (such as a spring or shock-absorbing body) has a problem in its ability to absorb collision-derived shock since the material itself has an elastic behavior. This type of device has an ability to reduce the speed of a colliding car and lower the shock of a very low speed car crash to some extent, but does not have enough capability against a higher speed car collision. This type of device also may possibly cause a secondary injury caused via elastic force.

The above-mentioned prior art method has a certain ability of absorbing colliding energy by making use of 2 mechanisms, one is deformation of a front-end pressure absorbing gum and rear end board; the other is a combination of a backlash effect of air pressure among a front-end pressure absorbing space, compressed air, and a vibration absorbing board space. It is not sufficiently capable, however of absorbing enough energy during a collision shock such as a car crash and cannot absorb sufficient collision energy. This results in a failure to secure the safety of the driver and the passengers.

### SUMMARY OF THE INVENTION

The invention provides a shock-absorbing bumper device having a simple, low cost and low weight structure that is both easy to install and take off. This invention also exhibits high performance in absorbing collision energy to secure the safety of the occupants of a vehicle having a bumper, especially an automobile.

This invention solves all of the problems mentioned as limiting the ordinary bumper. It is targeted to employ a simple structure, ease of assembly and disassembly, and high performance in absorbing colliding energy, which prevents a driver and passengers from severe injury caused by a car colliding into another vehicle or object. One embodiment utilizes a mid-filler attachment having a horizontal cross-section forming a shape that resembles an Ohm or S configuration within the shock-absorbing device in order to overcome the aforementioned problems.

Another embodiment utilizes a mid-air pipe within the above-described device to overcome the problems.

A further embodiment uses a mid-filler device with a shock-absorbing material shaped as a lotus root or loofah placed within the device described above in order to overcome the problems.

The above-described structures can be placed into the shock-absorbing device between the car frame and its bumper to overcome the problems the mentioned. The above-described structures include those that can be easily removed and replaced and those that are permanently affixed and not easily removed to overcome the recited problems. The shock-absorbing device that utilizes the mid-filler attachment having the horizontal cross section with an Ohm or S-shaped configuration, and those that also may contain a mid-air pipe within the bumper and the mid-filler attachment will be squashed with irreversible change at a time of crash or bumper impact.

This bumper device will absorb collision energy coming straight or even at an angle, which reduces the impact of the incident. This shock-absorbing device has an easy format to be put on and taken off quickly with low effort. When the mid-air pipe is utilized within the mid-filler attachment, the device has the capability of absorbing collision energy on the order of about 4 times or more compared with one that does not employ a midair pipe. This reduces the speed of a colliding car and lowers the impact of a car crash.

When the lotus root or loofah shaped shock-absorbing material is filled with additional impact absorbing materials within the mid-filler attachment, it will be squashed with an irreversible change at the time of a car crash impact together with the mid-filler attachment and absorb additional collision energy. This reduces the speed of the colliding car and, in turn, reduces the total impact energy of the incident transferred to the vehicle occupants.

An object of the invention is to provide a simple structure to facilitate easy removal from a car frame and side door, and enhance economical efficiency.

Another object is to provide a mid-filler attachment that may be positioned vertically; this shock absorber is robust even against vertical load. If a load, such as a person, is placed on the bumper, it will not be squashed.

A further object is to reduce the impact energy when a car is crashed straight into wall by both squashing the mid-filler attachment and the shock-absorbing material, which combine to efficiently absorb collision energy, which in turn reduces the speed of the colliding car and eases the shock of the collision.

A yet further object is for the shock absorbing device to be made without elastic material, in spite of the fact that many others use them, as it will eliminate the transmission of an elastic force to a driver, which prevents the driver (and passengers) from secondary injuries caused by the elastic (restoring) force.

### BRIEF DESCRIPTION OF THE DRAWINGS

FIG. 1 depicts a cross-sectional view of one embodiment of the shock-absorbing device.

FIG. 2 depicts a cross-sectional view of one embodiment of the shock-absorbing device after being squashed.

FIG. 3 depicts a cross-sectional view of another embodiment of shock-absorbing device (mid-filler attachment) Shock absorbing material is not shown

FIGS. 4 (a)-(c) shows cross-sectional views of different embodiments of the ohm-shaped shock-absorbing device utilizing one of the other mid-filler attachments discussed herein.

FIG. 5 depicts a cross-sectional view of another embodiment of the shock-absorbing device.

FIG. 6 depicts a cross-sectional view of another embodiment of the shock-absorbing device related with this invention wherein two of the ohm-shaped mid-filler attachments are placed in a back-to-back position.

FIG. 7 depicts a cross-sectional view of another embodiment of the shock-absorbing device with an S-shaped mid-filler attachment placed at both edges of an ohm-shaped mid-filler attachment.

FIG. 8 (a) depicts a cross-sectional view of another embodiment of the mid-filler attachment.

FIG. 8 (b) depicts a cross-sectional view of another embodiment of the shock-absorbing device utilizing several mid-filler attachments that are interconnected together into a larger single unit.

FIG. 9 depicts a cross-sectional view of an ordinary shock-absorbing body.

### DETAILED DESCRIPTION OF THE INVENTION

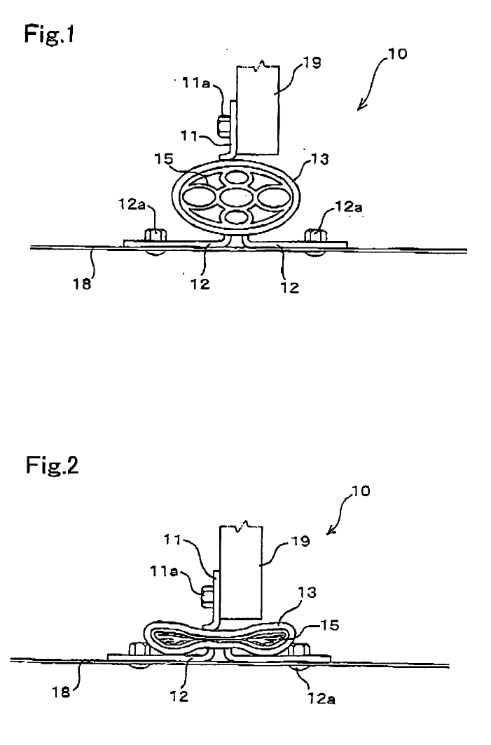

FIG. 1 shows a cross-sectional view of a main shock absorbing device 10 attached to bumper 18. FIG. 2 is the same embodiment shown after an impact to the bumper deforms the shock-absorbing device 10.

In FIG. 1, one embodiment of the shock-absorbing device 10 consists of 3 main parts. The first part of the assembly is a first arm 11 that, when in use, is in the bumper and is attached to the car frame 19 by a connecting attachment 11a (ex. bolt, screw, rivet, adhesive or equivalent). The second part of the assembly is a second arm 12 that, when installed, is attached to bumper 18 by a fastening device 12a (ex. bolt, screw, rivet, adhesive or equivalent). The third part of the assembly is the mid-filler attachment 13 that connects first arm 11 and second arm 12. The mid-filler attachment 13 optionally contains a shock-absorbing material 15 that can be made of plastic or other equivalent shock absorbing materials or combinations thereof that are shaped to form a lotus root or loofah like structure, which is used to fill the inside of mid-filler attachment 13.

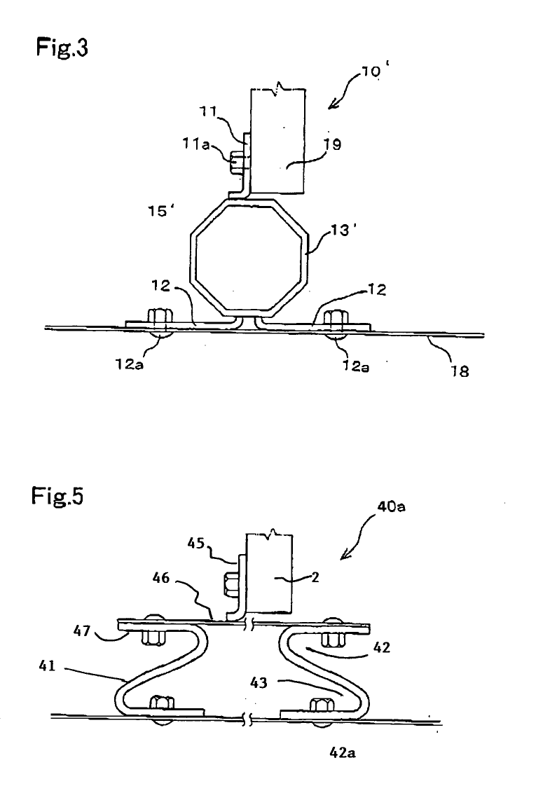

Mid-filler attachment 13 can be made of metal and is hollow with an elliptical cross section shape. The cross sectional shape can be any polygon such as that shown in FIG. 3. Its size and design can also be varied according to a requirement for the individual application.

The car frame side of the mid-filler attachment 13 has the first arm 11 preferably permanently affixed by welding or other equivalent method in order to allow the easy attachment or removal of first arm 11 to the car frame 19 by bolt or other means of similar attachment. The mid-filler attachment 13 is permanently joined to second arm 12 preferably also by welding or an equivalent method of permanently affixation to permit the attachment to Bumper 18 by removable fasteners such as bolts or screws.

The shock absorbing material 15 can be made of epoxy resin or metal and set along an axis line within mid-filler attachment 13. However, this does not limit the kind of shock-absorbing material to be used. (For example, plastic is suitable in terms of cost and ease of making). Heat reversible resin or heat-hardening resin are also suitable materials. It should be understood that these illustrative examples do not limit the scope of this invention as to the number of shock-absorbing material 15 that can be used, the size and shape of the shock absorbing material 15, and the entire shape. Therefore, these must be adaptable and available for re-design based on the desired energy absorption characteristics required.

The shock absorbing material 15 must fit within the hollow of mid-filler attachment 13 and provide sufficient energy absorption of the structure and material described above. Moreover, material, size, and shape of the mid-filler attachment 13 and shock-absorbing material 15 can be changed (varied) so as to optimize cushioning performance according to application, such as kind of car, its speed, its weight, etc.

Shock-absorbing assembly 10 has a simple structure, modest manufacturing cost, and promotes ease of installation and removal from both the bumper and the car frame without the expenditure of considerable time or effort.

Since the mid-filler attachment 13 is likely to be positioned vertically, this shock absorber is robust even when exposed to a vertical load. Thus, the application of a substantial force on the bumper, such as the case of a person standing on the bumper it will not be squashed. The mid-filler attachment 13 does not have to have a bottom plate and lid (regardless of how it is attached) it is encouraged to prevent any obstruction while the mid-filler attachment 13 is squashed because it may lead to a reduced performance. If a bottom plate or lid is provided, though it must be of a construction to not impede the absorption of forces during impact of the bumper.

As shown in FIG. 2, when a car is crashed straight into wall, the crushing of the mid-filler attachment 13 combined with the squashing of the shock-absorbing material 15 absorbs the collision energy more effectively, which in turn reduces the speed of the colliding car and eases the shock of the collision on any occupants of the car.

Since this shock-absorbing device does not employ elastic material, unlike many others use them, it will not transmit an elastic force to a driver, which prevents the driver (and its passengers) from secondary casualty caused by the elastic (restoring) force.

There is a fear that if the rigidity of the mid-filler attachment 13 and shock-absorbing material 15 are too small or too large, they will not perform well and cannot absorb the energy of a colliding car in some circumstances. Thus, there remains the possibility of decreasing the safety of any occupants of the vehicle. The system allows for the bumper to be optimized for certain characteristics of the vehicle, such as weight, and anticipated crash situations such as speed and angle of collision, but the system will not prevent transfer of collision energy to the occupants of the vehicle in every potential collision.

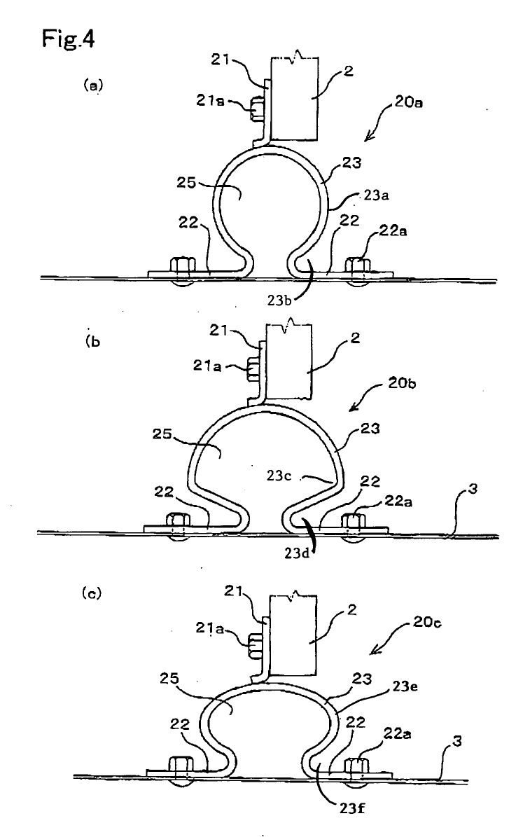

FIGS. 4 (a-c) shows a cross section of a main portion of a shock-absorbing device 20a, 20b, 20c utilizing a different embodiment of the mid-filler attachment. FIGS. 4 (a-c) does not include images of the shock-absorbing material 25 that can be placed within the shock-absorbing device 20a, 20b and 20c respectively, to increase absorption of impact forces during a collision with the bumper.

The shock-absorbing devices 20a-20c have an ohm mid-filler section 23, with the bumper side formed so that horizontal cross-section forms a shape similar to that of the ohm symbol with a hollow center formed therein. The ohm shape is a portion of the radius of a circle 23a that transitions into at least one bumper arm 22 for attachment to bumper 3. The transition 23b between the radius of the circle and at least one bumper arm is an angle of about 30 to 120 degrees to that of the bumper arm 22. The frame arm 21 is permanently affixed at the car frame side of ohm mid-filler attachment 23 by welding or other similar permanent method of attachment. The frame arm 21 is then attached to the car frame 2 by bolting or other method of attachment to allow for ease of removal and reattachment.

The ohm shape can also be a portion of a radius of a circle that has both an inside angle 23c and an outside angle 23d that transitions into at least one bumper arm 22 as displayed in FIG. 4b. The inside angle 23c can range from 50-130 degrees. The outside angle 23d can range from 10-85 degrees, preferably 20-75 degrees. The bumper arm 22 is positioned for easy attachment to, and removal from, bumper 3.

The ohm shape can also be a portion of the diameter of an oval 23e that transitions into at least one bumper arm 22. The portion of the oval 23e that transitions into at least one bumper arm 22 has an outside angle of 20-90 degrees an illustrative example of which is provided in FIG. 4c. The bumper arm 22 is designed for easy attachment and removal from the bumper 3.

The shock-absorbing device 20a-20c can also optionally contain shock-absorbing material 25(15) shaped to fit within the hollow portion of the ohm mid-filler 23.

FIG. 5 shows another embodiment of the mid-filler attachment 23 that consists of at least one S-shaped arm. The S-shaped arm 41 consists of a first angle 42 and a second angle 43, each about 10-85 degrees. The S-shaped arm 41 has at least one bumper arm 22 for easy attachment and removal from the bumper 3. The S shape has a top arm 47 which is either directly connected to the s-frame arm 45 or to a cross span 46 that is attached to the s-frame arm 45. The s-frame arm 45 is then attached to the car frame 2 preferably by bolting or other method of attachment to allow for ease of removal and re-attachment.

Several S-shaped members can be combined and distributed to several points with a proper span to increase energy absorption. Also the S-shape can be used as double S-shape mid-filler attachment by combining 2 or more groups in parallel.

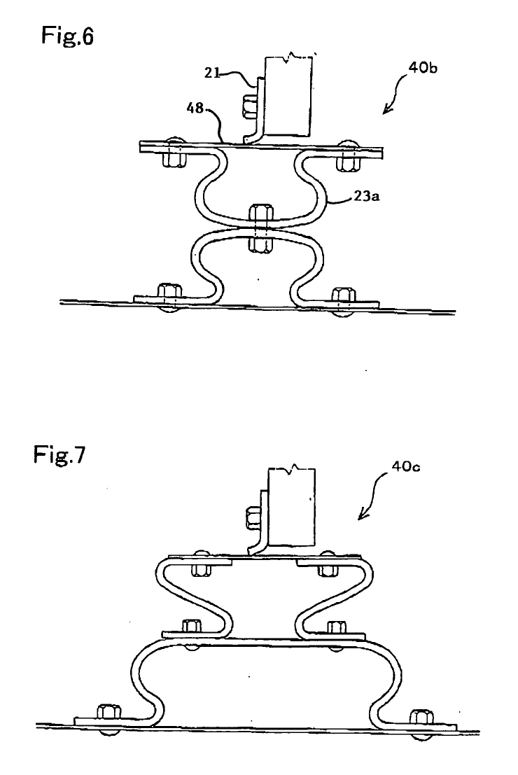

FIG. 6 shows another embodiment of inverted ohm combination assembly 40b utilizing at least two ohm shaped mid-filler attachment 23. A first ohm shaped mid-filler attachment 23 is attached to the bumper 3 as in FIG. 4 and a second ohm shaped mid-filler attachment 23a is inverted and affixed in a back-to-back position to the first ohm shaped mid-filler attachments 23. The second ohm shaped mid-filler attachments 23a is attached either directly to frame arm 21 or to a cross span 48 that is then, in turn, connected to frame arm 21.

FIG. 7 shows an embodiment where an ohm-shaped mid-filler attachment is combined with an S-shaped mid-filler attachment (for example), which unites the S-shape on both the edges of the ohm shape. As shown above, this invention can be implemented in several ways with any combination of Ohm and S-shaped members.

Better performance can be achieved by utilizing a combination of mid-filler attachments having different levels of performance (increased rigidity) in absorbing collision energy and distributing them to increase energy absorption relative to the placement. This structure allows a broad span in absorbing collision energy, in other words, the shock-absorbing device can have the capability of handling the entire spectrum of collisions, from a light, low speed-collision to a hard collision at high speeds or with hard immovable objects.

The structure that consists of an ohm-shaped mid-filler attachment having 2 types of rigidity (high and low) can be placed in a back-to-back position. Likewise, a structure that has an S-shape mid-filler attachment on both edges of an ohm-shaped mid-filler attachment can be designed to have a progressive increase in energy absorption to match the type of collision.

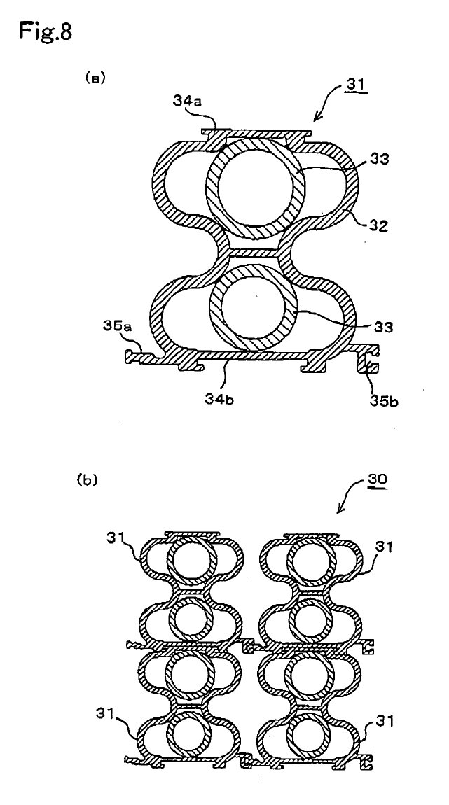

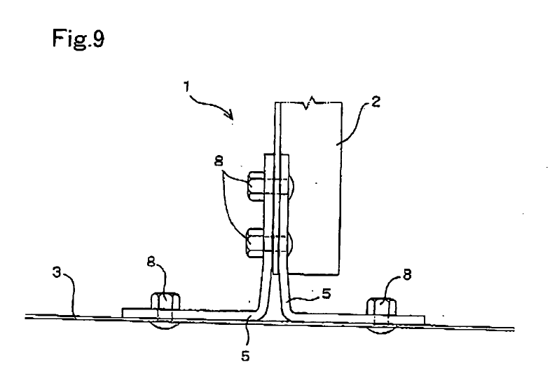

FIG. 8 (a) shows a cross-section of another embodiment with a unitized mid-filler attachment 31. The unitized mid-filler attachment 31 consists of a main body 32 that houses at least one mid-air pipe 33 within the interior portion of the main body 32. The main body 32 may then be used individually or combined with at least one additional unit of main body 32 within a housing in the bumper.

FIG. 8 (b) shows a cross section of unitized shock-absorbing device 30 that utilizes the combination of at least two unitized mid-filler attachments 31. Attached and fixed mid-filler attachments 31 are stored inside a housing and placed at the both front and rear ends of a car frame with an attaching format or a fixing format.

The main body 32 of mid-filler attachment 31 may be made by cutting a pipe, such as one made of aluminum (made by a drawing process) into optimum length. The mid-filler attachment 31 also contains a mid-air pipe 33 inside (fixed) that is also of the same length. Top connecter 34a and bottom connecter 34b are attached to connect in a cross direction. The top connecter 34a can be either male or female and is designed to interlock with bottom connecter 34b. Right connecter 35a and left connecter 35b are combined to connect in a horizontal direction. The right connecter 35a can be either male or female and is designed to connect to a left connecter 35b. As shown in FIG. 8(b) the connecting parts require the combination of at least two mid-filler attachments 31 within the housing. The mid-filler attachment 31 (together with the housing) are placed at both the front and the rear ends of a car frame with an attaching format or fixing format.

The Main body 32 of mid-filler attachment 31 has a simple structure and simple manufacturing, that eases the manufacturing process and can be made by the drawing process of aluminum. Material, size and shape of the mid-filler attachment and shock-absorbing material, and its combinational implementation can be changed (varied) so as to optimize the cushioning performance according to the application, such as the kind of car, its speed, weight, and so on.

The examples provided herein and the detailed description of the shock-absorbing device are but a few illustrative examples of the invention that should not be used to limit the usage of the shock-absorbing device as many different combinations are possible. The scope of the invention is intended to be defined only by the claims.

We claim:

1. A shock absorbing device comprising:
a first arm;
a second arm;
a mid-filler attachment having a hollow center wherein the first arm and the second arm are permanently affixed to the mid-filler attachment.

2. The shock of claim 1 further comprising:
a shock absorbing material affixed within the hollow center of the mid-filler attachment.

3. The shock of claim 2 wherein the shock absorbing material is formed into a shape selected from the group consisting of lotus root or loofah.

4. The shock of claim 1 further comprising:
an attachment means to allow for removal or attachment of the first arm to a car frame.

5. The shock of claim 1 further comprising:
an attachment means to allow for removal or attachment of the second arm to a bumper.

6. The shock of claim 5 further comprising:
a bumper.

7. A shock absorbing device comprising:
a frame arm;
at least one bumper arm;
an ohm-shaped mid-filler attachment having a hollow center wherein the frame arm and the bumper arm are permanently affixed to the ohm-shaped mid-filler attachment.

8. The device of claim 6 further comprising a shock-absorbing material placed within the hollow of the ohm mid-filler attachment.

9. The device of claim 7 wherein the ohm-shaped mid-filler attachment has
a portion of a radius of a circle that transitions into the at least one bumper arm; and,
an angle of about 10 to 120 degrees formed between the portion of a radius of a circle and the at least one bumper arm.

10. The device of claim 7 wherein the ohm-shaped mid-filler attachment has
a portion of a radius of a circle that transitions into the at least one bumper arm;
an outside angle of about 20 to 80 degrees to the at least one bumper arm; and,
an inside angle of about 50 to 120 degrees formed between the portion of a radius of a circle and the outside angle.

11. The device of claim 7 wherein the ohm-shaped mid-filler attachment has
a portion of a radius of an oval that transitions into the at least one bumper arm; and,
an angle of about 10 to 89 degrees formed between the portion of a radius of a circle and the at least one bumper arm.

12. A shock absorbing device comprising:
a frame arm;
at least one bumper arm;
a first ohm-shaped mid-filler attachment having a hollow center wherein the frame arm is permanently affixed to the ohm-shaped mid-filler attachment;
a second ohm-shaped mid-filler attachment having a hollow center and inverted with respect to the first ohm-shaped attachment and affixed to the first ohm-shaped mid filler attachment in a back-to-back position;
a cross span wherein the frame arm is permanently affixed to the cross span and to the second ohm-shaped mid-filler.

13. The device of claim 12 further comprising:
a shock absorbing material affixed within the hollow center of at least one of the ohm mid-filler attachments.

14. A shock absorbing device comprising:
at least one s-bumper arm comprising:
a first angle; and,
a second angle;
a frame arm permanently affixed to the s-bumper;
a top arm permanently affixed to the s-bumper.

15. The device of claim 14 further comprising:
a second s-bumper positioned parallel to the at least one s-bumper arm;
a cross piece attaching the top arm of the second s-bumper arm to the top arm of the at least one s-bumper arm, wherein the frame arm is connected to the top arm through the cross piece.

16. A shock absorbing device comprising:
at least one ohm mid-filler attachment having a hollow center;
a frame arm permanently affixed to the ohm mid-filler attachment;
at least one bumper arm;
at least one s-bumper attached to the ohm mid-filler attachment;
a frame arm permanently affixed to the s-bumper.

17. The device of claim 16 further comprising:
a cross span attached to two s-bumpers and permanently affixed to the frame arm.

18. A unitized shock absorbing device comprising:
a main body having an interior portion; and,
at least one midair pipe within the interior portion of the main body.

19. The device according to claim 18 further comprising:
a top connector affixed to the main body; and,
a bottom connector affixed to the main body and dimensioned to mechanically interlock with the top connector.

20. The device according to claim 18 further comprising:
a right connector affixed to the main body; and,
a left connector affixed to the main body and dimensioned to mechanically interlock with the top connector.

21. The device according to claim 19 further comprising:
a right connector affixed to the main body; and,
a left connector affixed to the main body and dimensioned to mechanically interlock with the top connector.

22. The device according to claim 18 wherein the main body is an extruded tube cut to a length.

23. The device according claim 19 wherein the midair pipe is cut to about the length of the main body.

24. The device according to claim 21 further comprising:
at least one additional unitized shock absorbing device wherein the right connector of at least one unitized shock absorbing device is mechanically interlocked with at least one left connector.

25. The device according to claim 21 further comprising:
at least one additional unitized shock absorbing device wherein the top connector of at least one unitized shock absorbing device is mechanically interlocked with at least one bottom connector.

26. The device according to claim 25 further comprising:
at least one additional unitized shock absorbing device wherein the top connector of at least one unitized shock absorbing device is mechanically interlocked with at least one bottom connector.

27. The device according to claim 21 further comprising:
a housing dimensioned to receive at least two unitized shock absorbing devices that are interlocked.

28. A method of making a unitized shock absorbing device comprising:
forming a main body having an interior portion and at least one pair of connectors dimensioned to mechanically interlock with each other;
cutting the main body into at least two pieces of a desired length;
providing a midair pipe with a length similar to that of the main body;
inserting the midair pipe into the interior portion.

29. The method of claim 28 further comprising:
interlocking the connectors of the two pieces of the main body;
providing a housing;
placing the interlocked connectors into the housing.

30. The method of claim 29 further comprising:
installing the housing into an automobile to absorb impact energy.

31. The method of claim 28 wherein the main body is formed through an extrusion process.
